(19) United States
(12) Patent Application Publication
(10) Pub. No.: US 2012/0024670 A1
(43) Pub. Date: Feb. 2, 2012

(54) Adjustable Rotational Discharge Assembly for a Conveyor

(76) Inventors: Robert Koerselman, Boyden, IA (US); Travis Johnson, Hartley, IA (US); Matthew Cato, Spencer, IA (US)

(21) Appl. No.: 12/846,202

(22) Filed: Jul. 29, 2010

(51) Int. Cl. B65G 33/00

(52) U.S. Cl. 198/671

(57) ABSTRACT

An adjustable rotational discharge assembly is provided comprising a linear motor, a pulley system assembly in operational communication with the linear motor, and a discharge chute in rotational communication with the pulley system. Linear motion from the linear motor is transformed by the pulley system into rotational motion, the rotational motion is communicated to the discharge chute to rotate the discharge chute between a storage position and an unload position.

### FIELD OF THE INVENTION

The present invention relates to a discharge assembly. More specifically, the present invention relates to an adjustable rotational discharge assembly connected to a conveyor.

### BACKGROUND

Conveyors for transporting and unloading products are known. In the agricultural industry, conveyors are used to transport agricultural products or materials. Conveyors provide quick and efficient transportation of agricultural products while minimizing damage to the products. Conveyors currently used to transport agricultural products frequently have a discharge chute positioned at the discharge end of the conveyor. The discharge chute is stationary in relation to the conveyor and directs the flow of the conveyed material, for example, toward the ground.

Conveyors having stationary discharge chutes are used to transport agricultural products from a harvesting vehicle, such as a combine harvester, into a storage or transportation vehicle, such as a dump truck or grain cart. A combine harvester has a limited storage capacity for receiving and storing harvested agricultural products. Accordingly, to maintain a high operational efficiency and to avoid frequent stopping to unload harvested agricultural products, combine harvesters will discharge the harvested agricultural products into a storage vehicle during the harvesting operation or combining process. In order to discharge the harvested agricultural products during operation, the conveyor of a combine harvester will extend a distance away from the combine harvester to allow a storage vehicle, such as a grain cart, to receive the conveyed agricultural products without interfering with the continuing harvesting operation or combining process. The storage vehicle will position itself in relation to the stationary discharge chute of the conveyor, such that the conveyer harvested agricultural products will discharge into a storage area of the storage vehicle.

Unfortunately, the foregoing arrangement of conveying harvested agricultural products has several drawbacks. Typically, the stationary discharge chute of a conveyor generates losses of the conveyed agricultural products during operation of the combine harvester. The losses can occur during the harvesting or combining operation of the combine harvester, for example, but not limited to, loss of product may occur prior to the positioning of the storage vehicle, after the storage vehicle has a filled storage area and pulls away from the combine harvester, loss of product may occur due to a speed differential between the operating combine harvester and the storage vehicle, due to separation of the combine harvester and storage vehicle such as when either the combine harvester or storage vehicle turns, swerves or moves and the other vehicle does not compensate, or during the positioning of the conveyor from a stored position to an operational, discharge position. Furthermore, parts of the storage vehicle, such as the tarp supports, can interfere with the combine harvester's discharge conveyor. The loss of harvested agricultural products results in a loss in revenue.

Some devices have attempted to address losses of agricultural products from combine harvester discharge conveyors. For example, combine harvester discharge conveyors may include a door or dribble door pivotally connected to the discharge chute of the conveyor. The dribble door attempts to reduce losses of conveyed agricultural products by covering a portion of the conveyor discharge chute. However, agricultural products losses can still easily occur with a dribble door, as small amounts of conveyed agricultural product may overcome any resistance the dribble door places against the conveyor discharge chute.

Second, the stationary discharge chute of the conveyor reduces the productivity and operational efficiency of the combine harvester. Due to the stationary position of the discharge chute, the conveyed agricultural products can only be directed into a specific area of a storage vehicle storage area. In order to evenly fill the storage vehicle storage area, the combine harvester and/or the storage vehicle must vary their respective operational speed to move the conveyed agricultural products into a different area of the storage vehicle. A slowing of the combine harvester decreases the rate of the harvesting operation or combining process.

Third, the stationary discharge chute of the conveyor results in the uneven filling of the storage vehicle. Often, only the operator of the combine harvester is in a position to view the storage area of the storage vehicle. Accordingly, only the combine harvester operator can ascertain the fill rate of the storage vehicle storage area, and likewise make adjustments to avoid uneven filling. As discussed above, to account for uneven filling of the storage vehicle, the combine harvester operator has to change the operational speed of the combine harvester in relation to the storage vehicle. This can result in a decrease in productivity and operational efficiency caused by a decrease in speed. In addition uneven filling of the storage vehicle can cause the overfilling of an area of the storage vehicle storage area, resulting in spilling or loss of conveyed agricultural products.

Some devices have attempted to address uneven filling of the storage vehicle. For example, United States Patent Publication Number 2009/0321154 to Johnson discloses a discharge chute which may provide rotation of the chute. However, Johnson does not disclose a chute which addresses losses of discharged material.

Accordingly, what is provided is an adjustable rotational discharge assembly for a conveyor as follows.

### SUMMARY OF THE INVENTION

An adjustable rotational discharge assembly for a conveyor is provided comprising a linear motor, a pulley system assembly in operational communication with the linear motor, and a discharge chute in rotational communication with the pulley system. Linear motion from the linear motor is transformed by the pulley system into rotational motion, the rotational motion is communicated to the discharge chute to rotate the discharge chute between a storage position and an unload position.

In another embodiment of an adjustable rotational discharge assembly, the assembly includes an actuator and a cover assembly having an opening. A pulley system assembly is carried by the cover assembly. The pulley system assembly includes a trolley assembly received by the opening and in communication with the actuator. A discharge chute is in rotational communication with the pulley system assembly through cables, the resulting motion from the actuator is transferred to the pulley system, the pulley system transfers the motion to the cables, and the cables rotate the discharge chute between a storage position and an unload position.

In another embodiment, a combine harvester discharge conveyor includes an adjustable rotational discharge assembly; the assembly comprises a linear drive assembly having a cylinder barrel in communication with a rod, the linear motor having a first end and a second end. The linear motor is in communication with a means of controlling the linear motor. A cover assembly is connected to the first end of the linear motor, the cover assembly including a first section, a second section connected to the first section at a first angle, and a third section connected to the first section at a second angle. An oblong aperture is positioned through the first section of the cover assembly, a first cable member is positioned on the first section of the cover assembly, and a second cable member is positioned on the first section of the cover assembly. A pulley system is carried by the cover assembly, the pulley system includes a trolley assembly received within the oblong aperture and connected to the second end of the linear motor, a first pulley and fifth pulley connected to the trolley assembly, a second pulley connected to the first section of the cover assembly, a third pulley connected to the second section of the cover assembly, a fourth pulley connected to the third section of the cover assembly. A drive ring assembly is in rotational communication with the pulley system through a long cable and a short cable, the cables having a first end or shank ball end and a second end or threaded end, the shank ball end of the long cable connected to the first cable member, the long cable connecting the first cable member to a portion of the first pulley, the long cable connecting the first pulley to a portion of the second pulley, the long cable connecting the second pulley to a portion of the third pulley, the threaded end of the long cable connecting the third pulley to a portion of the drive ring assembly, another portion of drive ring assembly connecting to the threaded end of the short cable, the short cable connecting the portion of the drive ring assembly to a portion of the fourth pulley, the short cable connecting the fourth pulley to a portion of the fifth pulley, the short cable connecting the fifth pulley with the second cable member, the shank ball end of the short cable connected to the second cable member. A discharge chute is connected to the drive ring assembly; the discharge chute is adapted to rotate between a grain savings position and a grain discharge position. A means for operating the adjustable rotational discharge assembly is connected to the linear motor.

### BRIEF DESCRIPTION OF THE DRAWINGS

FIG. 1 is a perspective view of a discharge assembly according to an embodiment of the present invention; the discharge assembly attached to a conveyor of a combine harvester, the conveyor and associated discharge assembly positioned in a stored position. The discharge assembly is connected to a relay that is connected to a foot switch and a battery; the foot switch is used to control the position of the discharge chute.

FIG. 2 is a plan view of the discharge assembly of FIG. 1, showing a combine harvester, the conveyor of the combine harvester and attached discharge assembly in the stored position in broken lines and the conveyor and attached discharge assembly in the discharge position in solid lines.

FIG. 2A is a cut away plan view of the discharge assembly of FIG. 1, taken from line 2A of FIG. 2, showing the discharge chute in an unrotated storage position and a cut-away of the cylinder cover assembly illustrating the electric actuator and associated wiring.

FIG. 2B is a cut-away plan view of another embodiment of the discharge assembly of FIG. 1, taken from line 2A of FIG. 2, showing the discharge chute in an unrotated storage position and a cut-away of the cylinder cover assembly illustrating the cylinder and associated hydraulic lines.

FIG. 3 is a perspective view of the discharge assembly of FIG. 1, illustrating the discharge chute in an unrotated storage position and without an associated conveyor.

FIG. 4 is an isometric view of the discharge assembly of FIG. 1, illustrating the discharge chute in a rotated unload position, a cut-away of the cylinder cover assembly illustrating the cylinder, the cylinder in partial broken lines, and excluding the discharge assembly cables.

FIG. 5 is an isometric view of the discharge assembly of FIG. 1, illustrating the discharge assembly shown in FIG. 4 with the discharge chute removed.

FIG. 6 is an exploded view of the discharge assembly of FIG. 1, illustrating the discharge assembly shown in FIG. 5 with the discharge chute and cables removed.

FIG. 6A is an exploded view of the drive ring retainer assembly shown in FIG. 6.

FIG. 7 is a partial exploded view of the discharge assembly of FIG. 1, taken from line 7-7 of FIG. 6, illustrating the cylinder cover assembly.

FIG. 7A is a partial exploded view of the trolley assembly of FIG. 7.

FIG. 7B is an exploded view of the pulleys used in the discharge assembly.

FIG. 8 is a cut-away plan view of the discharge assembly of FIG. 1, taken from line 8-8 of FIG. 5, illustrating an arrangement of the cables.

FIG. 9 is an isometric view of the discharge assembly of FIG. 1, illustrating the discharge chute in a fully rotated position.

FIG. 10 is a view of the components of the foot switch assembly and electrical components used to operate the discharge chute. FIG. 10 is for illustrative purposes and the components are not to scale.

FIG. 10A is a wiring diagram for the installation of the foot switch assembly and electrical components of FIG. 10.

### DETAILED DESCRIPTION

The following provides one or more examples of embodiments of an adjustable rotational discharge assembly 100. For ease of discussion and understanding, the following detailed description and illustrations refer to the discharge assembly 100 for use with a conveyor 20 connected to a combine harvester 19. It should be appreciated that the conveyor 20 may be any type, style, or arrangement of conveyor, including, but not limited to, an auger or screw conveyor, a belt conveyor, a pneumatic conveyor, a roller conveyor, a chain conveyor or any other known or future developed conveyor for which it would be advantageous to use one or more examples of embodiments of the adjustable rotational discharge assembly 100. In addition, while a combine harvester 19 is provided for purposes of illustration, it should be appreciated that the conveyor 20 and associated adjustable rotational discharge assembly 100 may be connected to any type of vehicle, machine, equipment or device which requires or desires a conveyor 20.

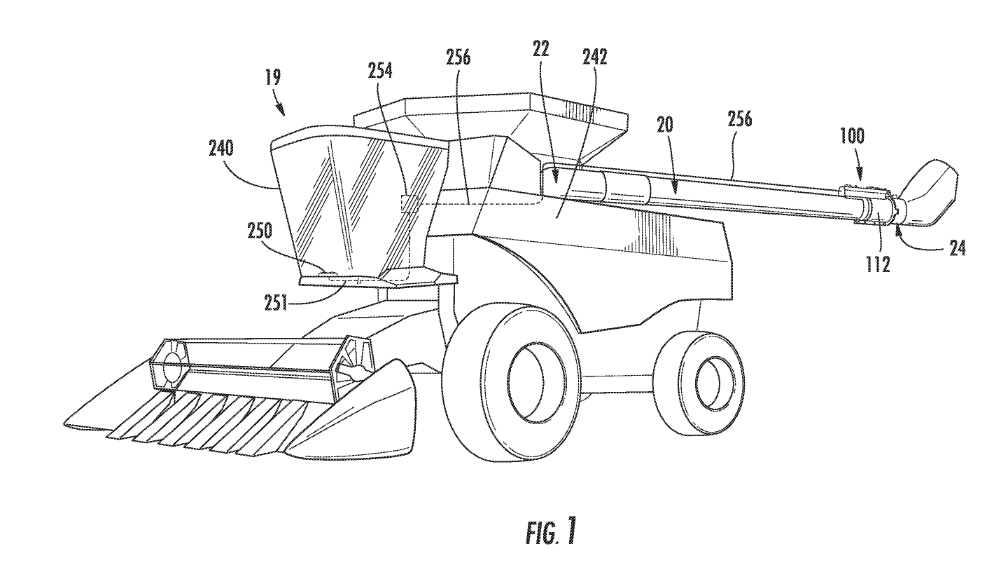

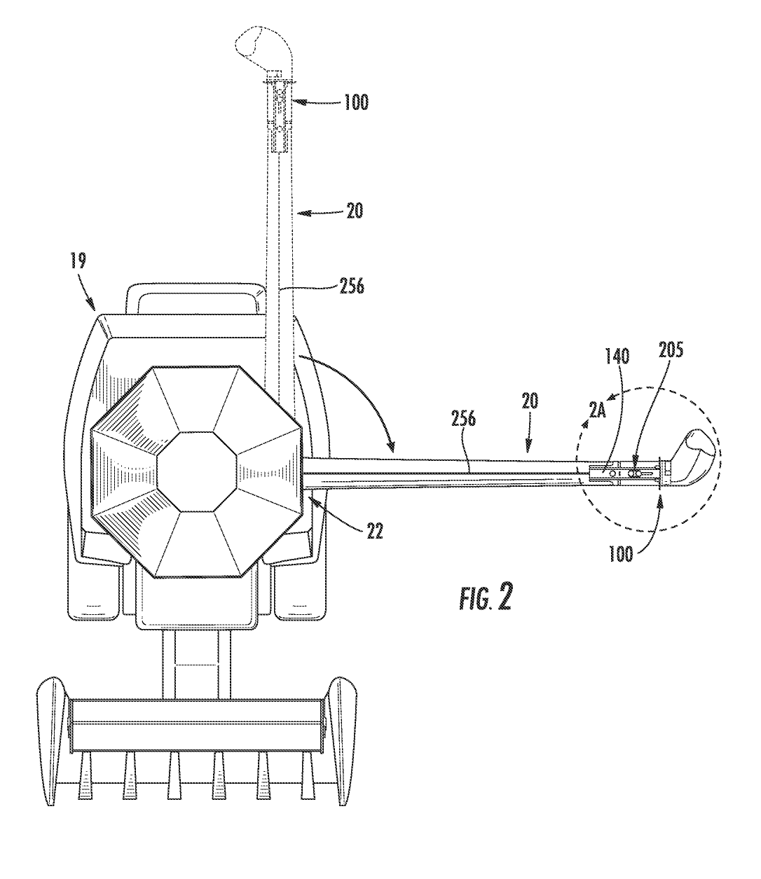

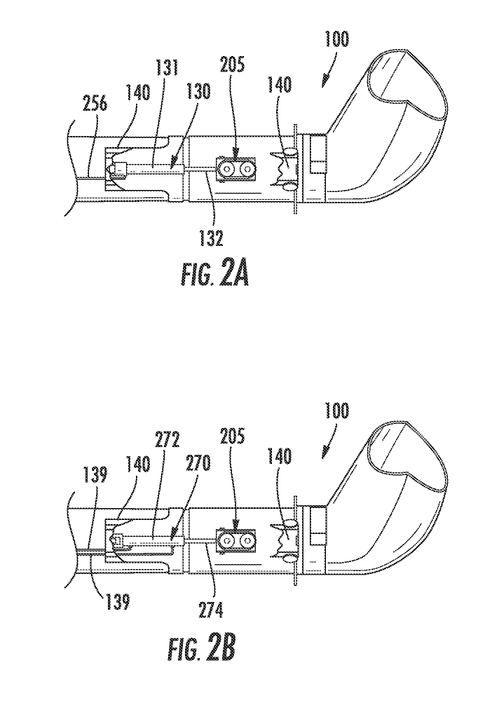

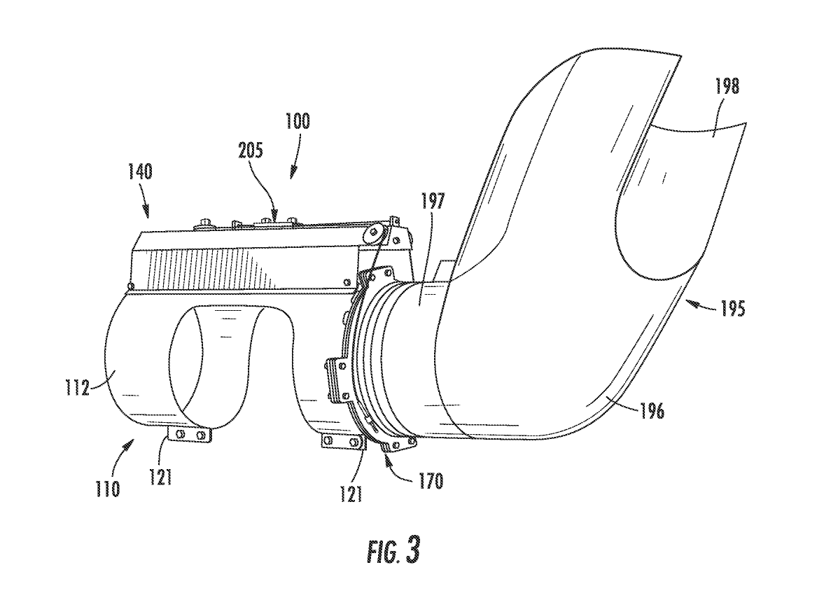

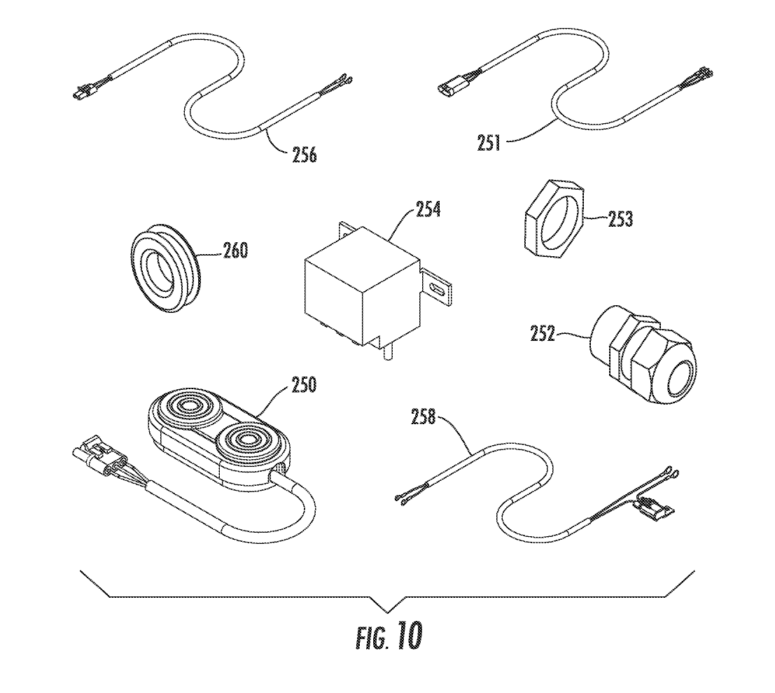

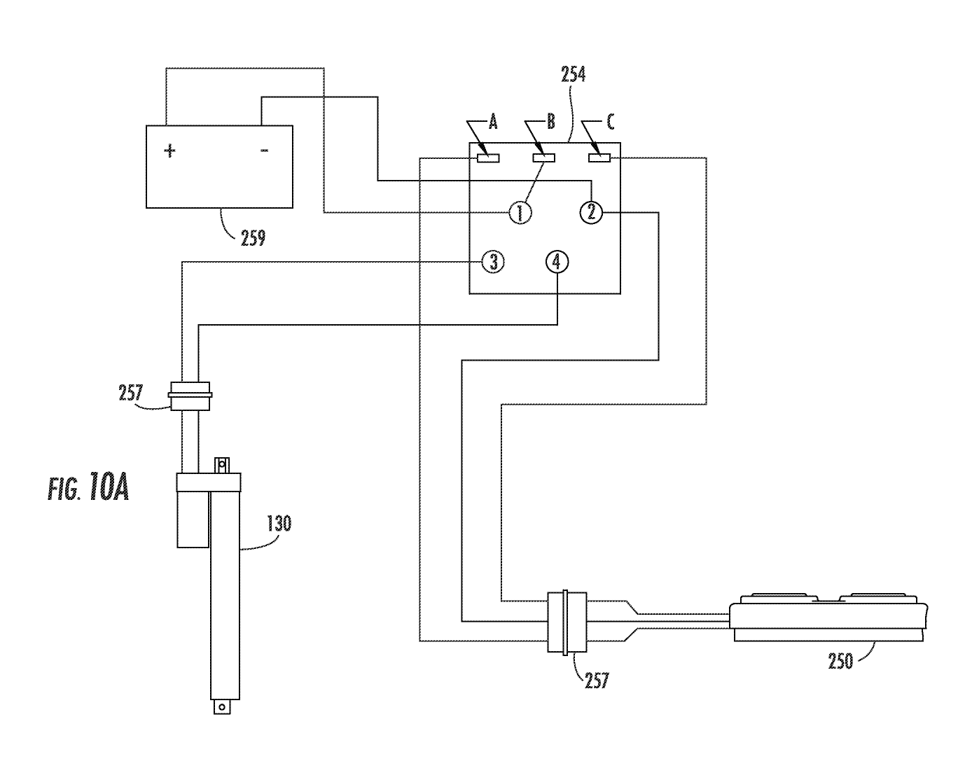

FIG. 1 illustrates a perspective view of a combine harvester 19. The combine harvester 19 includes a conveyor 20, illustrated in a stored position. In the stored position, the conveyor 20 is approximately parallel to the operational or driving direction of combine harvester 19. The conveyor 20 includes a first or intake end 22 and a second or discharge end 24. The intake end 22 is in pivotal communication with the combine harvester 19. Connected to the discharge end 24 is an adjustable rotational discharge assembly 100. Connected to the adjustable rotational discharge assembly 100 is a means for operating the adjustable rotational discharge assembly 100, in the preferred embodiment the means for operating the adjustable rotational discharge assembly is a foot switch 250 located in the cab 240. The foot switch 250 is connected to a relay 254 located on the passenger side frame panel (not shown) behind the cab 240. The foot switch 250 is connected to the relay 254 by a foot switch harness 251. The relay 254 is connected to a battery 259 (shown in FIG. 10A) and to the adjustable rotational discharge assembly 100. The adjustable rotational discharge assembly 100 is connected to the relay 254 by an actuator harness 256 that runs along the top of the conveyor 20 and then under a side body panel 242 to the relay 254. While the preferred means to operate the adjustable rotational discharge assembly 100 is the foot switch 250, it should be appreciated that the means to operate the adjustable rotational discharge assembly 100 is not limited to the foot switch 250. Alternative embodiments may include the adjustable rotational discharge assembly 100 being operated by other means. For example, FIG. 2B illustrates a hydraulic actuator 270 connected to hydraulic lines 139 as the means for operating the adjustable rotational discharge assembly 100.

FIG. 2 illustrates an overhead view of the combine harvester 19. The combine harvester 19 includes the conveyor 20, illustrated in the stored position in broken lines and the discharge position in solid lines. The conveyor 20 can pivot about the intake end 22 between the stored position and the discharge position. In the discharge position, the conveyor 20 is approximately perpendicular to the operational or driving direction of combine harvester 19.

The conveyor 20 includes the adjustable rotational discharge assembly 100 connected thereto and illustrated in the storage position. The adjustable rotational discharge assembly 100 may include a cylinder cover assembly 140.

FIG. 2A illustrates a cut away plan view of the adjustable rotational discharge assembly 100, taken from broken line 2A of FIG. 2. A portion of the cylinder cover assembly 140 is cut-away to illustrate a linear drive assembly or linear motor or electric actuator 130. The electric actuator 130 may include a barrel 131 in linear communication with a rod 132. As illustrated in FIG. 2, the actuator harness 256 may extend from the electric actuator 130 along the conveyor 20 to the combine harvester 19. At the combine harvester 19, the actuator harness 256 may be run under the side body panel 242 behind the body panel hinges (not shown) of the combine harvester 19. The electric actuator 130 may be connected to electricity provided by the combine harvester 19 or by one or more batteries 259, include or exclude a piston, or any other known or future developed linear drive assembly or linear motion device to support operation of the adjustable rotational discharge assembly 100 as described herein.

FIG. 2B illustrates a cut away plan view of another embodiment of the adjustable rotational discharge assembly 100, taken from broken line 2A of FIG. 2, wherein the linear drive assembly is a hydraulic actuator 270. A portion of the cylinder cover assembly 140 is cut-away to illustrate a linear drive assembly or linear motor or piston cylinder or hydraulic actuator 270. The hydraulic actuator 270 may include a cylinder barrel 272 in linear communication with a piston rod 274. The cylinder barrel 272 may receive piston rod 274 and include a piston (not shown) or cylinder head (not shown). The hydraulic actuator 270 may be connected to a set of hydraulic lines 139 to respectively deliver and/or withdraw hydraulic fluid to the hydraulic actuator 270. The hydraulic lines 139 may extend from the hydraulic actuator 270 along the conveyor 20 to the combine harvester 19. At the combine harvester 19, the hydraulic lines 139 may be operably connected to a hydraulic system (not shown) of the combine harvester 19 which operates equipment or appendages connected to the combine harvester 19. In one or more examples of embodiments, the hydraulic lines 139 may be operably connected to a dedicated hydraulic system (not shown) independent of the combine harvester 19 yet carried by the combine harvester 19. In one or more examples of embodiments, hydraulic actuator 270 may include a single hydraulic line or three or more hydraulic lines. The illustration of the hydraulic actuator 270 is provided as an alternative embodiment and is in no way to be considered limiting, one who is ordinarily skilled in the art would understand that the adjustable rotational discharge assembly 100 may comprise any type of actuator that will support the operation of the adjustable rotational discharge assembly 100.

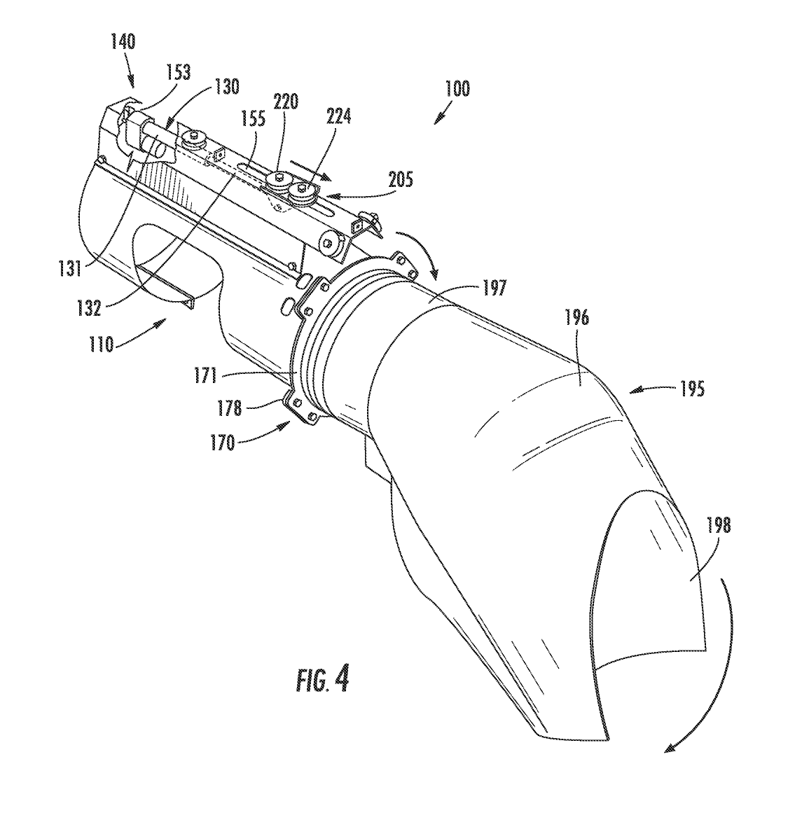

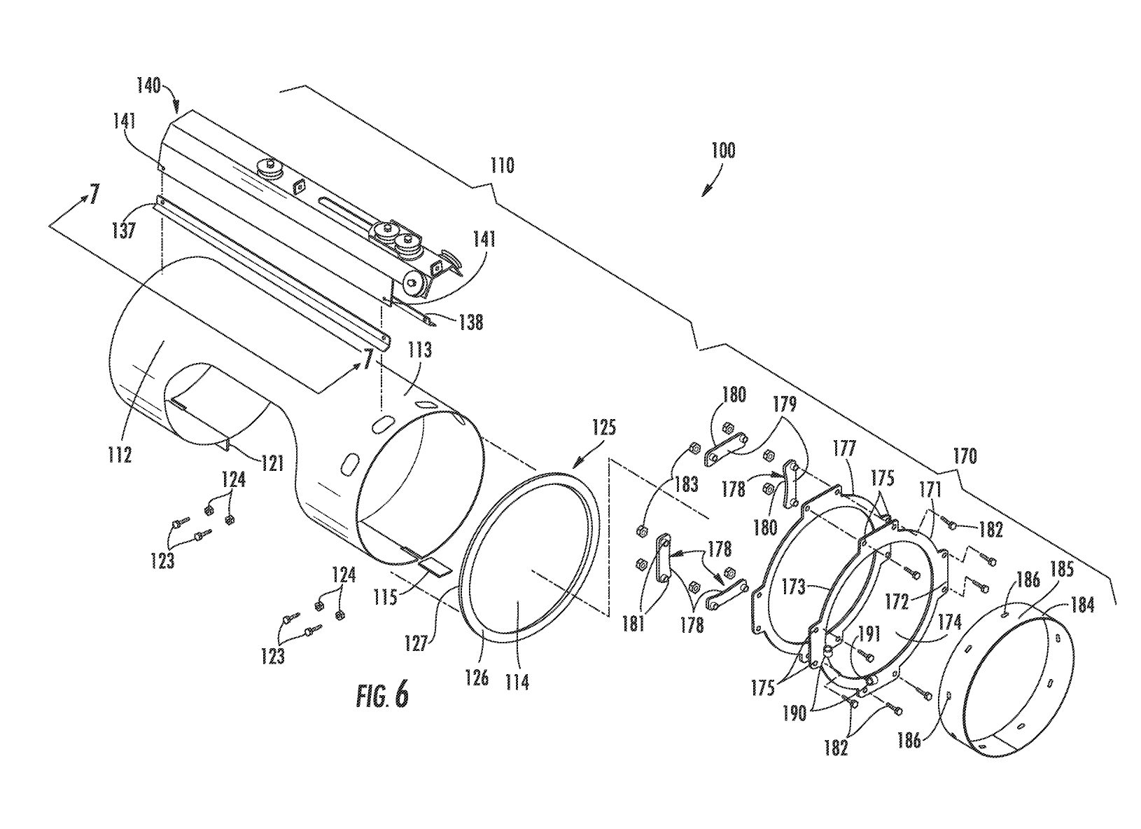

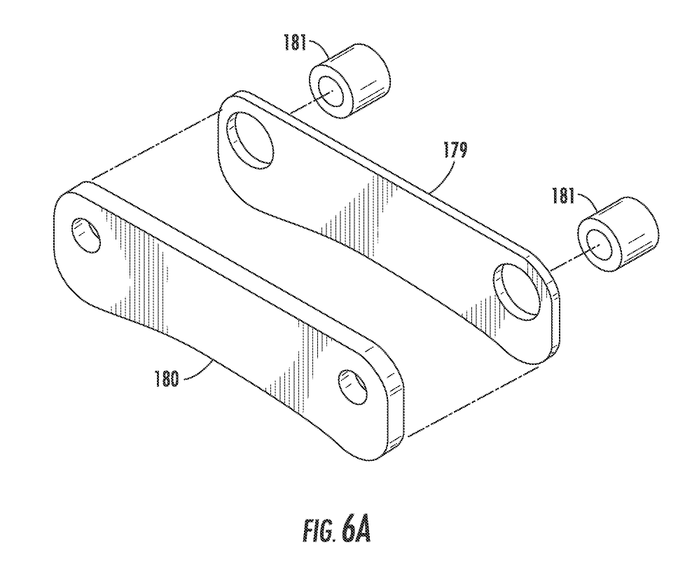

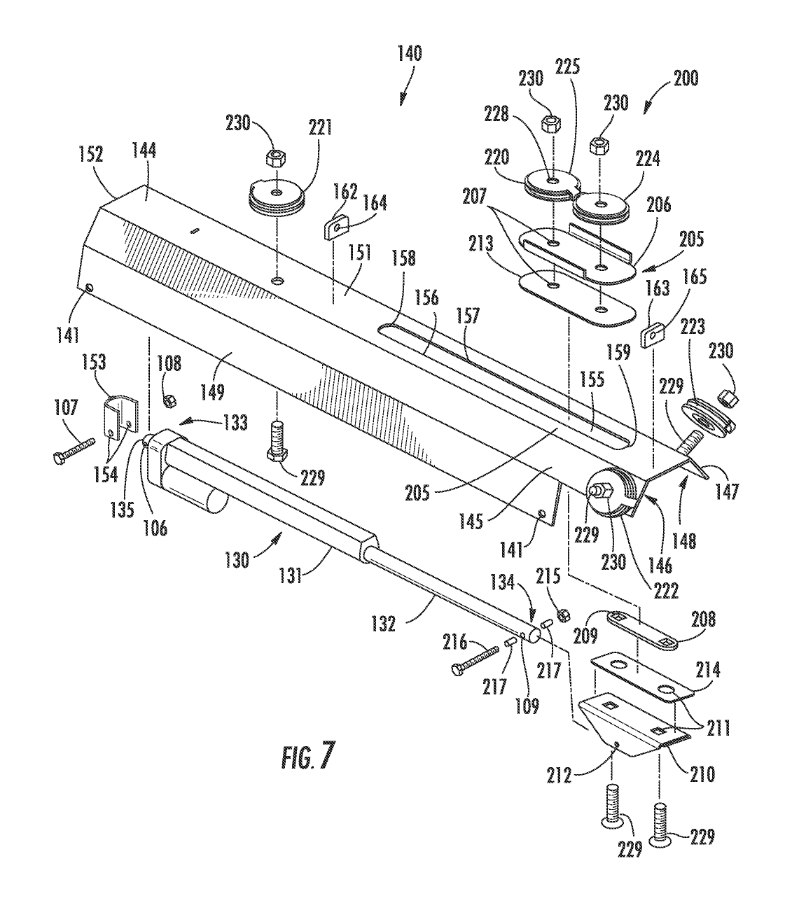

FIGS. 3-9 illustrate the adjustable rotational discharge assembly 100 in accordance with one or more embodiments of the present invention. Referring generally to FIGS. 3-6, 8 and 9, the adjustable rotational discharge assembly 100 may include a conveyor sleeve assembly 110. As illustrated in FIGS. 3 and 6, the conveyor sleeve assembly 110 may include a sleeve 112. In one or more examples of embodiments, the conveyor sleeve assembly 110 may be constructed as two sleeves, or may have three or more sleeves. The conveyor sleeve assembly 110 may be formed of steel, aluminum, plastic, or any other known or future developed metal, synthetic, or semi-synthetic material with sufficient strength and rigidity to support operation of the adjustable rotational discharge assembly 100 as described herein.

Referring to FIG. 6, the sleeve 112 may include an outer portion 113 and an inner portion 114. The inner portion 114 of sleeve 112 is illustrated as cylindrical in shape. Accordingly, the inner portion 114 is adapted to receive a portion of a correspondingly shaped conveyor. For example, as illustrated in FIG. 1, the sleeve 112 receives a portion of conveyor 20, which is illustrated as cylindrical in shape. The inner portion 114 is adapted to surround a portion of the exterior of the conveyor 20. In one or more examples of embodiments, the sleeve 112 may be formed of different geometries, shapes, sizes, lengths, diameters and/or arrangements. This advantageously allows the adjustable rotational discharge assembly 100 and associated sleeve assembly 110 to connect or attach to different styles, types, geometries, sizes, or brands of a conveyor 20.

As illustrated in FIG. 6, sleeve 112 may be connected by sleeve bracket members 121. The sleeve bracket members 121 may include one or more apertures (not shown). The bracket member apertures (not shown) may align and receive a bolt 123 and nut 124 to connect the sleeve 112. The removable connections described herein advantageously allows the adjustable rotational discharge assembly 100 and associated sleeve assembly 110 to be installed after the initial purchase or acquisition of a conveyor 20 or device having a conveyor 20. Accordingly, the adjustable rotational discharge assembly 100 may be sold as an aftermarket upgrade. In one or more examples of embodiments, the sleeve 112 may be attached by weld, adhesive, or any other known or future developed method of attachment having sufficient strength to connect sleeve 112 and support operation of the adjustable rotational discharge assembly 100 as described herein. Further, in one or more examples of embodiments, the sleeve 112 may be integrally formed with conveyor 20.

The sleeve 112 may include the raised lip or a sleeve ring 125. As shown in FIG. 6, the sleeve ring 125 is positioned around the circumference of the outer portion 113 of the sleeve 112. Accordingly, the diameter of the sleeve ring 125 is greater than the outer diameter of the sleeve 112. The sleeve ring 125 may include a front or first portion 126 and a rear of second portion 127. The front and rear portions 126, 127 may be arranged generally parallel to one another. The sleeve ring 125 may be welded to the sleeve 112. In one or more examples of embodiments, the sleeve ring 125 may be positioned at one or more locations along the sleeve 112. Further, in one or more examples of embodiments, the sleeve ring 125 may be attached to the first sleeve 112 by bolt, adhesive, or any other known or future developed method of attachment having sufficient strength to connect the sleeve ring 125 to sleeve 112 and support operation of the adjustable rotational discharge assembly 100 as described herein.

Referring generally to FIGS. 3-6, 8 and 9, the adjustable rotational discharge assembly 100 may include a drive ring assembly 170. The drive ring assembly 170 is in rotational communication with the sleeve ring 125. As illustrated in FIG. 6, the drive ring assembly 170 may include a chute drive ring 171 and a drive ring spacer 177. The chute drive ring 171 may have a front side or first portion 172 and a rear side or second portion 173. The rear side 173 may align with the drive ring spacer 177. The chute drive ring 171 and the drive ring spacer 177 may include a drive ring aperture or opening or hole 174. The drive ring aperture 174 may have a corresponding radius and/or circumference as the sleeve ring 125.

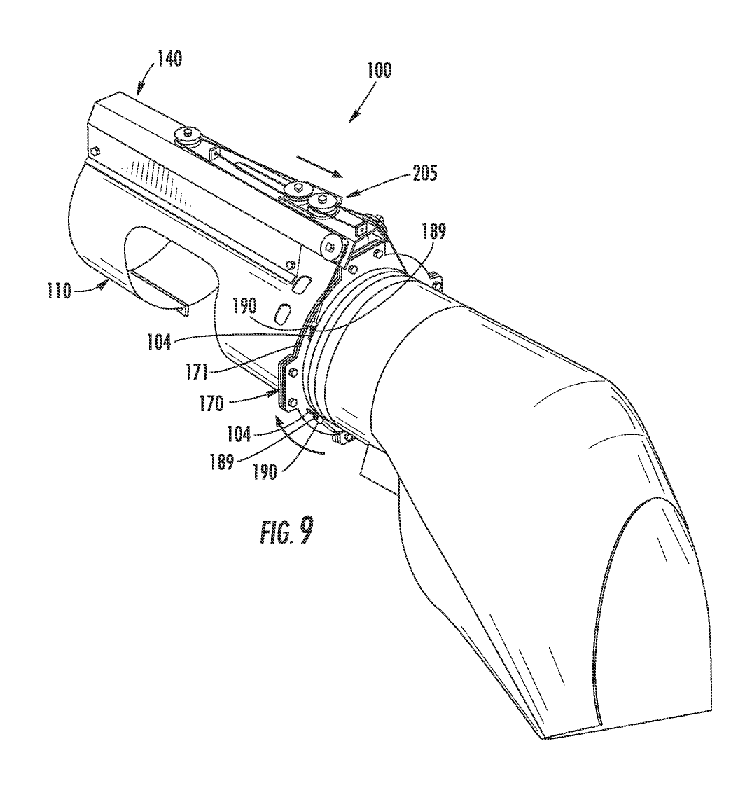

Referring to FIGS. 6 and 8, the chute drive ring 171 and the drive ring spacer 177 are adapted to rotationally engage the sleeve ring 125 through one or more ring retainer brackets 178. In the embodiment illustrated in FIG. 6, the chute drive ring 171 engages the sleeve ring 125 through four separate ring retainer brackets 178. In one or more examples of embodiments, the chute drive ring 171 may engage the sleeve ring 125 through one, two, three, or five or more ring retainer brackets 178. Further, in one or more examples of embodiments, the chute drive ring 171 may engage the sleeve ring 125 without a ring retainer bracket 178, but with any known or future developed suitable connection device in accordance with operation of the adjustable rotational discharge assembly 100 as described herein.

Each ring retainer bracket 178 includes a drive ring retainer 180 and a drive ring retainer spacer 179 illustrated in FIG. 6A. The ring retainer bracket 178 may also include a bushing or sleeve 181. As shown in FIG. 6 and FIG. 6A of the illustrated embodiment, each ring retainer bracket 178 includes two bushings 181. Each bushing 181 is adapted to receive a ring connection member or bolt 182. The ring connection member 182 may include external threads, which may engage corresponding internal threads (not shown) within bushing 181. In one or more examples of embodiments, the each ring retainer bracket 178 may include one or three or more bushings 181. Further, in one or more examples of embodiments, bushing 181 may include an aperture having a smooth bore for receiving a ring connection member 182. The smooth bore enables a portion of the ring connection member 182 to pass through bushing 181 and through an aperture (not shown) in bracket 178, such that the ring connection member 182 engages or connects to an internally threaded member, for example, but not limited to, a nut, on the rear portion 180 side of bracket 178.

The chute drive ring 171 is adapted to rotationally engage the sleeve ring 125 by arranging each ring retainer bracket 178 such that the drive ring retainer spacer 179 is in communication with the second portion 127 of the sleeve ring 125. Further, the rear side 173 of chute drive ring 171 is in communication with the drive ring spacer 177 which is in communication with the sleeve ring 125. Each ring retainer bracket 178 subsequently connects to the chute drive ring 171. For example, as shown in FIG. 6, each ring connection member 182 passes through a corresponding connection aperture or bolt hole 175 in the chute drive ring 171. A portion of each ring connection member 182 enters the connection aperture 175 from the front side 172 of the chute drive ring 171. The ring connection member 182 portion subsequently passes through the connection aperture 175 and engages a corresponding bushing 181 of a ring retainer bracket 178.

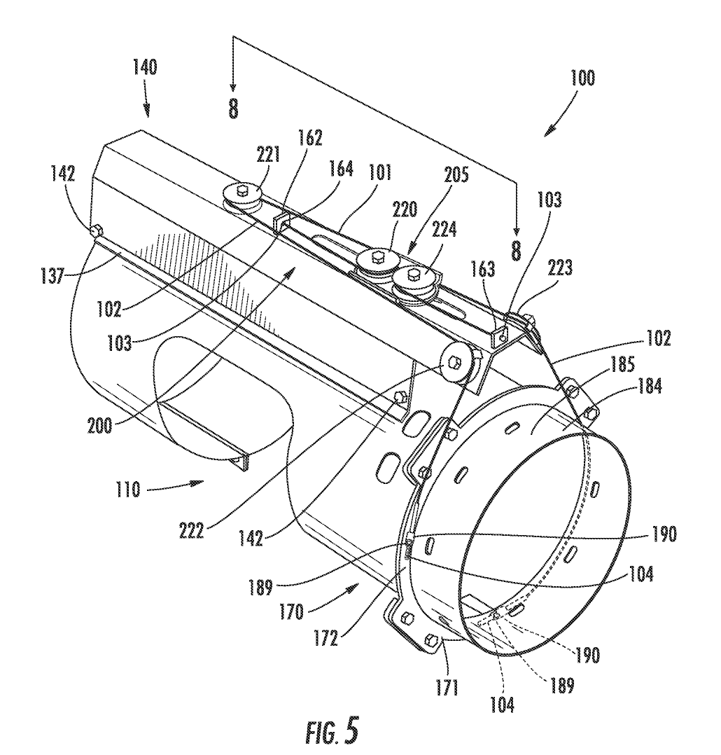

As shown in FIGS. 5, 6 and 8, the chute drive ring 171 may carry a drive bushing 190. In one or more examples of embodiments, and as illustrated in FIG. 6, the chute drive ring 171 may carry a plurality of drive bushings 190. Each drive bushing 190 includes an aperture or opening 191 which passes entirely through the bushing 190. Accordingly, the bushings 190 are adapted to receive cables 101, 102 through opening 191 (see FIG. 5). Further, aperture 191 may engage the cables 101, 102 such that as the cables 101, 102 move, the bushings 190 correspondingly move with the cables 101, 102. For example, apertures 191 may have a diameter corresponding to the outer diameter of the cables 101, 102 such that the bushings 190 may receive the cables 101, 102, yet forms a connection with the cables 101, 102. Accordingly, as the cables 101, 102 move, bushings 190 correspondingly move. In one or more examples of embodiments, bushings 190 may engage the cables 101, 102 through frictional engagement, may include one or more retention members, such as a nut 189, or may include any other known or future developed retention device to enable the bushings 190 to receive and subsequently move with the cables 101, 102. Further, in one or more examples of embodiments, the bushings 190 may be mounted or connected to chute drive ring 171 by weld, adhesive, or any other known or future developed method of attachment.

100441 The chute drive ring 171 may carry a chute retention element 184 (see FIGS. 5 and 6). The chute retention element 184 may be cylindrical in shape and includes an outer surface 185. A plurality of chute ring apertures or retention apertures 186 may be connected to or arranged around the outer surface 185. The chute retention element 184 may be connected to the chute drive ring 171 by welding. In one or more examples of embodiments, the chute retention element 184 may be any shape or geometric orientation adapted to engage or retain a discharge chute 195. Further, in one or more examples of embodiments, the chute retention element 184 may be connected to the chute drive ring 171 by any known or future developed method of attachment suitable to support operation of the discharge assembly 100 as described herein.

As shown by reference to FIGS. 3 and 4, the discharge chute 195 is mounted or attached to chute retention element 184. The discharge chute 195 provides for the directional distribution of material from the conveyor 20. In the illustrated embodiment, the discharge chute 195 includes an elbow 196 positioned between a conveyor attachment end 197 and a discharge end 198. The discharge chute 195 mounts to the discharge assembly 100 through the conveyor attachment end 197 receiving the chute retention element 184. As shown in FIGS. 5 and 6, the retention apertures 186 are along the outer surface 185 of chute retention element 184 and are adapted to assist in retaining discharge chute 195. In one or more examples of embodiments, one or more hose clamps (not shown) may be fastened about the conveyor attachment end 197 of the discharge chute 195. For example, the hose clamp (not shown) may include a screw and band or worm gear assembly to provide additional adjustable attachment or retention of the discharge chute 195 to the chute retention element 184. Further, in one or more examples of embodiments, the hose clamp may be a spring clamp, wire clamp, or any suitable compression fitting assembly suitable to provide additional connection of discharge chute 195 to the chute retention element 184. In one or more examples of embodiments, the discharge chute 195 may connect to the chute retention element 184 by screws, bolts, adhesive, welding or any other known or further developed attachment device or method.

The adjustable rotational discharge assembly 100 may include cylinder cover assembly 140. Referring generally to FIGS. 3-6, 8 and 9, conveyor sleeve assembly 110 may carry the cylinder cover assembly 140. As shown in FIGS. 5 and 8, cover mounts 137, 138 may be connected to the conveyor sleeve assembly 110, for example, but not limited to, by weld. In one or more examples of embodiments, the cover mounts 137, 138 may be connected to the conveyor sleeve assembly 110 by bolt, adhesive, or any other known or future developed method of attachment suitable to support operation of the discharge assembly 100 as described herein. The cover mounts 137, 138 may include a plurality of apertures (not shown). The apertures (not shown) may correspond to apertures or holes or passages 141 positioned in the cylinder cover assembly 140 (see FIGS. 6 and 8). As shown in FIG. 5, connection members or bolts 142 may removably connect apertures 141 to the apertures (not shown) of the cover mounts 137, 138, connecting the cylinder cover assembly 140 to the conveyor sleeve assembly 110. In one or more examples of embodiments, the cylinder cover assembly 140 may be directly connected to the conveyor sleeve assembly 110, for example by weld, adhesive, or any other known or future developed method of attachment.

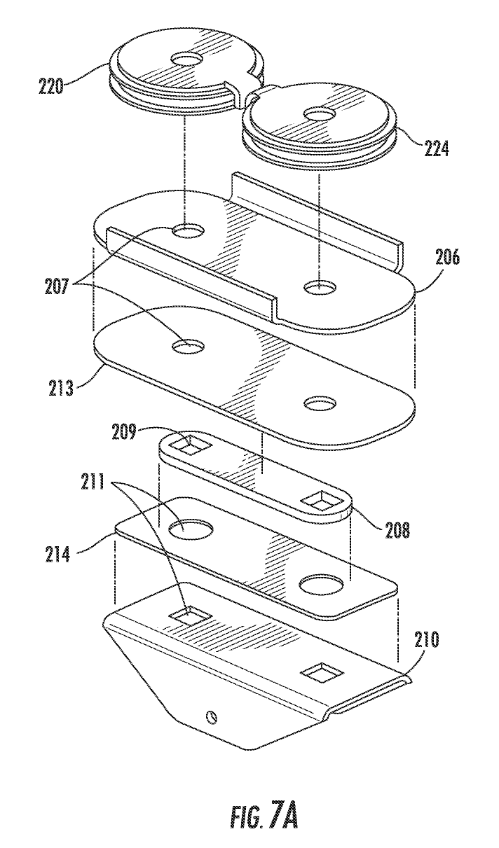

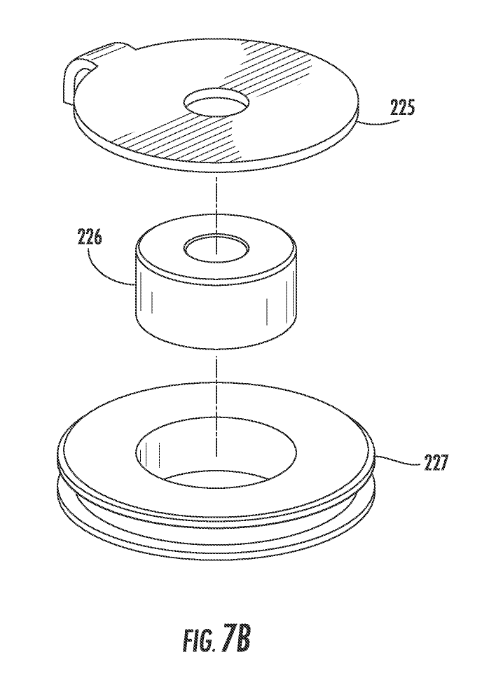

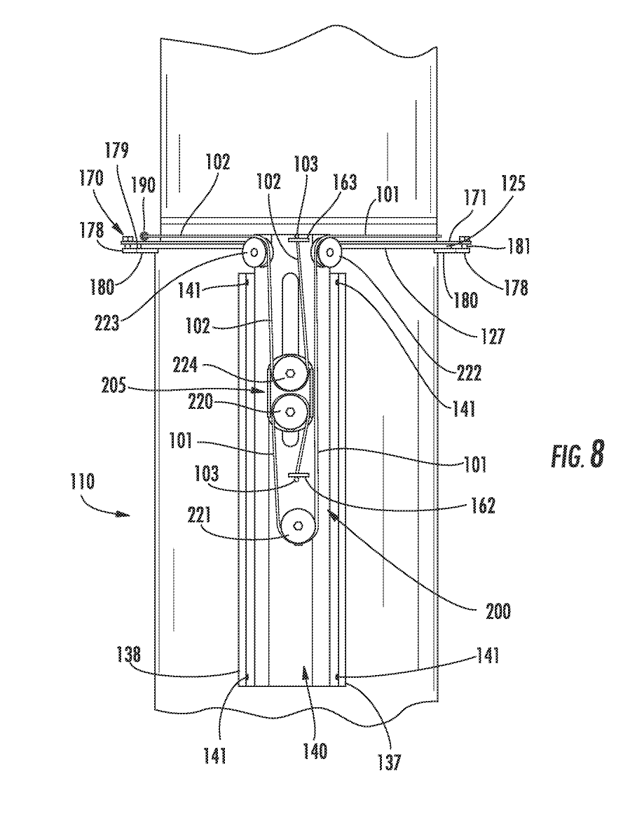

As shown in FIG. 7, the cylinder cover assembly 140 may include a first or top section 144. A second section 145 may be integrally connected to the first section 144 and positioned at a first angle 146 from the first section 144. Preferably the first angle 146 is greater than ninety (90) degrees. A third section 147 may be integrally connected to the first section 144 and positioned at a second angle 148 from the first section 144. Preferably the second angle 148 is greater than ninety (90) degrees. Accordingly, when viewing a cross-section of the cylinder cover assembly 140, the cross-section taken perpendicularly through the cylinder cover assembly 140 and the first, second and third sections 144, 145, 147, the second section 145 and third section 147 may be arranged as a mirror image of one another. A fourth section 149 may be integrally connected to the second section 145. The fourth section 149 may carry apertures 141 for connecting the cylinder cover assembly 140 to the conveyor sleeve assembly 110. The sections 144, 145, 147, 149 of the cylinder cover assembly 140 are arranged to form an outer surface 151 and an inner surface 152. While the sections and respective angles are specifically described with respect to the illustrated embodiment, one of skill in the art would understand that fewer or additional sections may be added or removed, the sections may be arranged at different angles, or the sections may be unitary, separately connected, or a combination thereof without departing from the overall scope of the present invention.

The cylinder cover assembly 140 may include an opening or passage or aperture or slot 155. As shown in FIG. 7, the opening 155 may be positioned in the first section 144 of cylinder cover assembly 140. The opening 155 may include first and second opening portions 156, 157, which are arranged substantially parallel to one another and separated by third and fourth opening portions or ends 158, 159. The opening 155 may be oblong or elongated in one direction. For example in the illustrated embodiment the first and second opening portions 156, 157 have a greater length or extend a greater distance than the third and fourth opening portions or ends 158, 159. In one or more examples of embodiments, opening 155 may be rectangular, oval, elliptical, or any other geometric orientation to allow for operation of the adjustable rotational discharge assembly 100 as described herein. Further, in one or more examples of embodiments, first and second opening portions 156, 157 of opening 155 may be any length suitable for operation of the adjustable rotational discharge assembly 100 as described herein.

The cylinder cover assembly 140 may include one or more cable tabs or members 162 for the engagement and retention of the cables 101, 102. As shown in the embodiment illustrated in FIGS. 5, 7 and 8, the cylinder cover assembly 140 may include a first cable tab 162 and a second cable tab 163. Cable tabs 162, 163 may be connected or attached to the cylinder cover assembly 140, for example, but not limited to, by weld. Each cable tab 162, 163 may include an aperture or opening 164, 165 (see FIG. 7). The cable tabs 162, 163 may be arranged approximately perpendicular to the cylinder cover assembly 140, for example perpendicular to the first section 144. In one or more examples of embodiments, the cylinder cover assembly 140 may include one cable tab or three of more cable tabs. Further, in one or more examples of embodiments, the cable tabs 162, 163 may be formed as a unitary member with the cylinder cover assembly 140 or arranged at an angle other than perpendicular to the cylinder cover assembly 140.

The cylinder cover assembly 140 may carry electric actuator 130. As illustrated in FIGS. 4 and 7, a cylinder mount post or member or support 153 may be connected to the inner surface 152 of the cylinder cover assembly 140. The cylinder mount post 153 may include apertures or passages or holes 154 for the selective engagement with electric actuator 130. Referring to FIG. 7, the electric actuator 130 may include a first end 133 and a second end 134. The first end 133 may be adapted to engage or mount or connect to cylinder mount post 153. In the illustrated embodiment, the first end 133 of the electric actuator 130 may include an engagement portion 135. The engagement portion 135 may include an aperture 106 which engage or connect to the cylinder mount post 153. Aperture 106 may be aligned with aperture 154 of cylinder mount post 153. Apertures 106, 154 may receive a connection member or threaded bolt 107 which engages a corresponding threaded nut 108, connecting the electric actuator 130 to the cylinder mount post 153. In one or more examples of embodiments, the cylinder mount post 153 may be connected to the cylinder cover assembly 140 by a weld, adhesive, bolt, may be integrally formed with the cover assembly 140, or any other known or future developed method of attachment or connection. Further, in one or more examples of embodiments, the cylinder mount post 153 may be formed separately from the cylinder cover assembly 140. In one or more examples of embodiments, engagement portion 135 may be formed of a single member, or multiple members, or may be connected or attached to cylinder mount post 153 by weld, adhesive, or any other known or future developed method of attachment.

Referring to FIGS. 7 and 8, the cylinder cover assembly 140 may carry pulley system assembly 200. The pulley system assembly 200 may be a compound pulley arrangement, in that the assembly 200 may include one or more fixed pulleys and one or more movable pulleys. The pulley system assembly 200 may include one or more pulleys in moveable communication with a trolley assembly 205 and one or more static or fixed pulleys. Referring to the embodiment illustrated in FIG. 7, the pulley system assembly 200 includes five total pulleys. A first pulley 220 and a fifth pulley 224 are respectively connected to or received by trolley assembly 205. A second pulley 221 is attached or connected to the first section 144 of the cylinder cover assembly 140. A third pulley 222 is attached or connected to the second section 145 and a fourth pulley 223 is attached or connected to the third section 147 of the cylinder cover assembly 140. The second, third and fourth pulleys 221, 222, 223 are each fixed or static pulleys, in which each pulley is connected in a fixed or static position, and only provides for rotational movement around a fixed axle or shaft. Further, the second, third and fourth pulleys 221, 222, 223 are arranged in the same plane or parallel to the respective first, second, or third section 144, 145, 147 to which each pulley is attached. Each pulley 220, 221, 222, 223, 224 may have a similar construction and include a cable retainer 225, a sheave bushing 226, and a cable sheave 227, illustrated in FIG. 7B. The cable sheave 227 may include a groove or slot or channel about the circumference of the cable sheave 227 for receipt of a cable or cord or belt, such as cables 101, 102 (shown in FIG. 8), The cable sheave 227 may include an opening or aperture or passage 228 passing entirely through cable sheave 227. Opening 228 may receive a member or axle or shaft 229 which the cable sheave 227 may rotate about. Member 229 may be a threaded member, a partially threaded member, or an unthreaded member, for example, but not limited to, a pin, a bolt, or a shaft. The illustrated embodiment of member 229 includes external threads which mate with an internally threaded member or nut 230. While the number, arrangement and types of pulleys are specifically described with respect to the illustrated embodiment, one of ordinary skill in the art would understand that fewer or additional pulleys may be added or removed, the pulleys may be arranged at different angles or positions, or the individual pulleys may be of a different type of pulley without departing from the overall scope of the present invention.

Trolley assembly 205 carries and provides traveling movement or lateral movement of one or more pulleys. As shown in the embodiment illustrated in FIG. 7, trolley assembly 205 may be positioned to movably engage opening 155. To this end, trolley assembly 205 may include a trolley top or cradle 206. The trolley cradle 206 carries the first and fifth pulleys 220, 224. Generally, the trolley cradle 206 may be positioned on the outer surface 151 side of the cylinder cover assembly 140. In communication with the trolley cradle 206 may be a trolley top spacer 213. In communication with the trolley top spacer 213 may be an actuator trolley spacer 208. The actuator trolley spacer 208 may be adapted to fit within opening 155 of the cylinder cover assembly 140. Accordingly, the actuator trolley spacer 208 may laterally guide the top trolley spacer 213 and the trolley cradle 206 along opening 155. A trolley bottom 210 may be in communication with a trolley bottom spacer 214. The trolley bottom spacer 214 may be in communication with the actuator trolley spacer 208. Generally, the trolley bottom 210 may be positioned on the inner surface 152 side of the cylinder cover assembly 140. The trolley cradle 206, trolley top spacer 213, actuator trolley spacer 208, trolley bottom spacer 214, and trolley bottom 210 may each have one or more apertures or openings 207, 209, 211 for receipt of a corresponding pulley sheave member 229 and subsequent connection of one or more pulleys. FIG. 7A illustrates an exploded view of the trolley assembly 205. One who is ordinarily skilled in the art would understand that the trolley assembly 205 may include any number of spacers and may be of any size and shape that will support the adjustable rotational discharge assembly 100.

Referring to FIG. 7, the electric actuator 130 may be in operable communication with the pulley system assembly 200. Trolley bottom 210 may include an attachment portion 212, illustrated as one or more apertures passing through a portion of the trolley bottom. The second end 134 of the electric actuator 130 may include a corresponding trolley engagement portion 109 including an aperture. Attachment portion 212 and trolley engagement portion 109 mate in order to align the corresponding apertures and receive a connection member 216. Connection member 216 is illustrated as a threaded member, such as a bolt, which mates with a tightening member 215, illustrated as a nut, and bushings 217. In one or more examples of embodiments, the trolley bottom 210 may connect to the electric actuator 130 by weld, adhesive, or any other known or future developed method of attachment suitable for operation of the discharge assembly 100 as described herein.

The electric actuator 130 may be in operational communication or operably connected to the drive ring assembly 170 to control the rotational movement of the drive ring assembly 170. More specifically, the electric actuator 130 may be in operational communication with the pulley system assembly 200. The pulley system assembly 200 may also be in communication with the drive ring assembly 170 through cables or cords or belts 101, 102. Accordingly, the pulley system assembly 200 described herein transmits linear motion transmitted from the electric actuator 130 into rotational motion transmitted through the cables 101, 102 to the drive ring assembly 170. Specifically, cables 101, 102 interconnect the pulley system assembly 200 with the drive ring assembly 170. As shown in FIG. 8, long cable 101 and short cable 102 include a first end or shank ball end 103 and a second end or threaded end 104 (shown in FIG. 5). Referring to FIGS. 5 and 8, the first end 103 of the long cable 101 connects to or engages first cable tab 162. The first cable tab 162 receives the first end 103 though aperture 164. Traveling from the first end 103 toward the second end 104, long cable 101 subsequently engages or wraps around a portion of the first pulley 220. Subsequently, cable 101 is directed to engage a portion of the second pulley 221, followed by a portion of the third pulley 222. The third pulley 222 redirects long cable 101 to engage drive ring assembly 170. Long cable 101 travels along a portion of chute drive ring 171 and the second end 104 engages or is received by one or more drive bushings 190. The drive bushings 190 may be connected to the chute drive ring 171. The short cable 102 continues to travel around a portion of the chute drive ring 171 and a portion of the chute retention element 184 and/or conveyor attachment end 197 of discharge chute 195. Following engagement with drive ring assembly 170, short cable 102 engages a portion of the fourth pulley 223. The fourth pulley 223 redirects the short cable 102 to engage a portion of the fifth pulley 224. From the fifth pulley 224, the first end 103 of the short cable 102 connects to or engages second cable tab 163. The second cable tab 163 receives the first end 103 though aperture 165. Accordingly, the electric actuator 130 may be operable to control the rotation of the drive ring assembly 170 and the attached discharge chute 195 through actuation of the pulley system assembly 200 and the subsequent movement of the cables 101, 102. In one or more examples of embodiments, the first ends 103 of the cables 101, 102 may be respectively retained by the first and second cable tabs 162, 163 by a retention device (not shown) such as a knot, a clip, a button, or other known or future developed device for retaining cables 101, 102 in apertures 164, 165 of the first and second cable tabs 162, 163. Further, in one or more examples of embodiments, cables 101, 102 may be arranged with the pulley system assembly 200 such that the cables 101, 102 are a continuous loop or continuous cable.

In operation and use of one or more examples of the discharge assembly 100, rotation of the discharge chute 195 may be accomplished by actuation of electric actuator 130. Referring to FIGS. 2, 2A and 3, discharge assembly 100 is positioned in a storage or grain savings position. As shown in FIG. 3, in the storage or grain savings position, the discharge end 198 of discharge chute 195 is positioned upward or away from the ground. Accordingly, any material in the attached conveyor 20 will collect or remain in the discharge chute 195, rather than immediately fall out and become waste. This advantageously allows a user to reduce the potential loss of conveyed material, specifically saving grain, as the discharge end 198 of discharge chute 195 is not directed toward the ground. Further, as shown in FIG. 2A, in the storage or grain savings position, the electric actuator 130 is in a retracted position, wherein the rod 132 is not fully extended. Correspondingly, the trolley assembly 205, which is in communication with the electric actuator 130, is positioned to one end of opening 155. As illustrated in FIG. 2 and referencing FIG. 7, in the storage position the trolley assembly 205 is positioned adjacent to or near the third opening portion or end 158. This arrangement advantageously minimizes loss of conveyed material. While the structural arrangement of the discharge assembly 100 in the storage position is specifically described with respect to the illustrated embodiment, one of skill in the art would understand that the operational arrangement of the structural features for the storage position may be altered or adjusted without departing from the overall scope of the present invention. For example, the storage or grain savings position of the discharge end 198 of discharge chute 195 may be any position in relation to the ground in which conveyed material, including grain, would remain in the discharge chute 195 and not immediately fall out of the discharge chute 195 and onto the ground. This would include, but is not limited to, positioning the discharge end 198 of discharge chute 195 parallel to the ground, or at an upward position away from the ground, such as an acute or orthogonal angle in relation to the horizon or ground. As another example, the electric actuator 130 may instead be extended or partially extended and/or the trolley assembly 205 may be positioned at the opposite end of opening 155, such as near the fourth opening portion or end 159.

To change the position of the discharge assembly 100 from the storage or grain savings position to the unload or grain discharge position, wherein the discharge end 198 of discharge chute 195 is positioned downward or toward the ground, electric actuator 130 may be actuated to provide motion in a first direction. The electric actuator 130 subsequently transmits the motion to the pulley system assembly 200, resulting in rotation of the discharge chute 195 in a first direction. FIG. 4 illustrates operation of electric actuator 130 in accordance with one or more examples of embodiments of the present invention. FIG. 4 specifically excludes the cables 101, 102, illustrates cylinder cover assembly 140 in a partial cut-away view, and shows electric actuator 130 in partial broken lines to provide an unobstructed view of operation of the electric actuator 130. In the illustrated embodiment, a user may initially provide an actuation command or communication to the electric actuator 130. Subsequently, electric actuator 130 will actuate, providing motion in a first direction, illustrated as linear motion. The first direction is illustrated as from cylinder mount post 153 toward discharge chute 195. Linear motion is provided in the first direction as the rod 132 extends away from the cylinder barrel 131. The electric actuator 130 transmits the linear motion to the pulley system assembly 200, which in turn transforms the linear motion provided by the electric actuator 130 to rotational motion in a first direction. Specifically, trolley assembly 205, which is in communication with the electric actuator 130, moves laterally with the rod 132 along opening 155. The trolley assembly 205 receives and subsequently transmits or communicates the linear motion to the connected or attached first and fifth pulleys 220, 224. In turn, the first and fifth pulleys 220, 224 transfer the motion to the cables 101, 102, moving the cables 101, 102 in a first direction. Cables 101, 102 subsequently rotate the drive ring assembly 170 in a first direction, resulting in the rotation of discharge chute 195 in a first direction. FIG. 5 illustrates the discharge assembly 100 of FIG. 4 with cables 101, 102, however excludes discharge chute 195.

Referring generally to FIGS. 4 and 5, the trolley assembly 205 and associated first and fifth pulleys 220, 224 are positioned along opening 155 at a position which corresponds with discharge chute 195, and specifically discharge end 198, facing downward and toward the ground. Preferably, the position of trolley assembly 205 along opening 155 is between the third opening portion or end 158 and the fourth opening portion or end 159 (see FIG. 7). Accordingly, this provides for additional rotation of the discharge chute 195 in the first direction. As shown in FIG. 9, trolley assembly 205 may move in the first direction along opening 155 until reaching the fourth opening portion or end 159 (see FIG. 7). As the trolley assembly 205 continues to move in the first direction, motion is transferred to cables 101, 102, continuing to move cables 101, 102 in the first direction, resulting in further rotation of drive ring assembly 170 and discharge chute 195 in the first direction. Accordingly, the drive ring assembly 170 and attached discharge chute 195 may rotate less than or in excess of 360 degrees. In one or more examples of embodiments, the amount of rotation of discharge chute 195 may be adjustable, for example, but not limited to, adjusting the length of the first and second opening portions 156, 157 of opening 155 or the length of extension of the electric actuator 130. Further, in one or more examples of embodiments, the amount of rotation of discharge chute 195 may be greater than 90 degrees and up to or exceeding 360 degrees.

A user may rotate the discharge chute 195 in a second, opposite direction through the retraction of the electric actuator 130. As rod 132 retracts in a second, opposite direction, the motion is transmitted to trolley assembly 205. Trolley assembly 205 accordingly moves in a second, opposite direction. In turn, the trolley assembly 205 transmits the motion to cables 101, 102, resulting in the cables 101, 102 moving in a second, opposite direction. Accordingly, cables 101, 102 rotate the drive ring assembly 170 and discharge chute 195 in a second, opposite direction. Upon the complete retraction of the electric actuator 130 and/or the trolley assembly 205 coming into communication with an end of opening 155, for example the third opening portion or end 158 (see FIG. 7), the discharge chute 195 will have rotated in the second, opposite direction to return to the storage position. A user may control and adjust the position of discharge chute 195 by actuating the electric actuator 130 in the first and second directions. This provides a user the ability to control the direction of distribution of conveyed materials through discharge chute 195. Further, in some applications it allows a user to avoid a reduction in the rate of productivity and operational efficiency caused to unload material. For example, in a combine harvester 19 application, a user may continue to operate the combine at a target production speed without slowing down to discharge combined or harvested material. Instead, the user can both control the direction of discharge flow to avoid uneven filling of a storage vehicle and reduce potential waste or loss of discharged material by rotating the discharge chute 195 into the storage position.

FIG. 10 illustrates the parts of the preferred means of controlling and adjusting the adjustable rotational discharge assembly 100. The electric actuator 130 (shown in FIG. 7) may be connected to the actuator harness 256. The actuator harness 256 may be connected to the relay 254. The relay 254 may be mounted on the passenger side frame panel (not shown) behind the cab 240. The relay 254 may be connected to the foot switch harness 251 and the power harness 258. The foot switch harness 251 may be run through the bulkhead panel (not shown) and a strain relief dome nut 252 and a strain relief lock nut 253 may be used to create a seal on the foot switch harness 251. The foot switch harness 251 may be connected to the foot switch 250. The foot switch 250 may be located inside the cab 240. The foot switch 250 may be used to control and adjust the position of the discharge chute 195 by actuating the electric actuator 130 in the first and second directions. The power harness 258 may be connected to the combine's battery 259 (shown in FIG. 10A). A hole (not shown) may be drilled on the rear side of the battery box (not shown) and a grommet 260 may fit into the hole (not shown). The power harness 258 may be run through the grommet 260 and connected to the battery 259 to provide power to the means of controlling the adjustable rotational discharge assembly 100. The actuator harness connection to the electric actuator 130 and the foot switch harness connection to the foot switch 250 may include a weather resistant seal 257. FIG. 10A is a wiring diagram illustrating how the foot switch 250 may be operably connected to the relay 254, electric actuator 130, and battery 259. While the preferred means to operate the adjustable rotational discharge assembly 100 is the foot switch 250, it should be appreciated that other means to operate the adjustable rotational discharge assembly 100 are possible. Furthermore, one who is ordinarily skilled in the art would understand that the orientation of the means of operating adjustable rotational discharge assembly 100 may be arranged in any way that will support the operation of the adjustable rotational discharge assembly 100.

The foregoing embodiments provide advantages over currently available devices. In particular the adjustable rotational discharge assembly 100 and associated features described herein allows for the reduction of losses in conveyed and discharged material, such as the savings of grain. Accordingly, the reduction of conveyed material losses, or grain savings, directly reduces revenue losses. In addition, the adjustable rotational discharge assembly 100 provides for the directional control of conveyed and discharged material. This advantageously allows a user to avoid uneven filling of a storage vehicle, device or assembly. The discharge assembly also helps the combine harvester's discharge conveyor 20 avoid parts of the storage vehicle reducing the chance the storage vehicle will interfere with the discharge conveyor 20. Further, in applications where discharge of material occurs during operation of additional equipment, for example, such as a combine harvester 19 discharging harvested or combined materials while continuing to operate or harvest, the adjustable rotational discharge assembly 100 reduces lost productivity or lost operational efficiency. For example, the combine harvester 19 does not need to reduce operational speed or stop to discharge harvested or combined materials. Instead, the combine operator can not only control the direction of conveyed and discharged materials, but can also position the adjustable rotational discharge assembly 100 into a storage position to reduce material losses while continuing to harvest or combine. In addition, the discharge assembly can be arranged and removably connected to different styles, types, geometries, sizes, or brands of a conveyor. Accordingly, the discharge assembly can be advantageously adapted and/or installed as an aftermarket upgrade to purchasers or owners of conveyors or conveying systems.

Although various representative embodiments of this invention have been described above with a certain degree of particularity, those skilled in the art could make numerous alterations to the disclosed embodiments without departing from the spirit or scope of the inventive subject matter set forth in the specification and claims. All directional references, including but not limited to, upper, lower, upward, downward, left, right, leftward, rightward, top, bottom, above, below, vertical, and horizontal are only used for identification purposes to aid the reader's understanding of the embodiments of the present invention, and do not create limitations, particularly as to the position, orientation, or use of the invention unless specifically set forth in the claims. Joinder references (e.g., attached, coupled, connected) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to certain embodiments, persons ordinarily skilled in the art will recognize that changes may be made in form and detail without departing from the spirit and scope of the invention.

What is claimed is:

1. An adjustable rotational discharge assembly for a conveyor comprising:
a linear drive assembly;
a pulley system assembly in operational communication with the linear motor; and
a discharge chute in rotational communication with the pulley system, wherein linear motion from the linear motor is transformed by the pulley system into rotational motion, the rotational motion is communicated to the discharge chute to rotate the discharge chute between a storage position and an unload position.

2. The adjustable rotational discharge assembly of claim 1, wherein the linear drive assembly includes an electric actuator.

3. The adjustable rotational discharge assembly of claim 1, wherein the linear drive assembly includes a hydraulic actuator.

4. The adjustable rotational discharge assembly of claim 1, wherein the pulley system includes a plurality of pulleys.

5. The adjustable rotational discharge assembly of claim 4, wherein the pulley system is carried by a cover assembly, the pulley system includes a trolley assembly received by a slot positioned in the cover assembly.

6. The adjustable rotational discharge assembly of claim 1, wherein the discharge chute is connected to a drive ring assembly, the drive ring assembly is in rotational communication with a conveyor.

7. The adjustable rotational discharge assembly of claim 6, wherein the drive ring assembly includes at least one cable, the cable interconnects the drive ring assembly to the pulley system.

8. The adjustable rotational discharge assembly of claim 7, wherein the pulley system communicates linear motion from the linear motor to the cable, the cable rotates the drive ring assembly, and the drive ring assembly rotates the discharge chute.

9. The adjustable rotational discharge assembly of claim 1, wherein the linear motor is connected to a means for operating the linear motor.

10. The adjustable rotational discharge assembly of claim 9, wherein the means for operating the linear motor is a foot switch.

11. An adjustable rotational discharge assembly comprising:
an actuator;
a cover assembly having an opening;
a pulley system assembly carried by the cover assembly, the pulley system assembly having a trolley assembly received by the opening and in communication with the electric actuator; and
a discharge chute in rotational communication with the pulley system assembly through at least one cable, the resulting motion from the electric actuator is transferred to the pulley system, the pulley system transfers the motion to the cable, and the cable, rotates the discharge chute between a storage position and an unload position.

12. The adjustable rotational discharge assembly of claim 11, wherein the cover assembly carries the actuator.

13. The adjustable rotational discharge assembly of claim 11, wherein the discharge assembly is connected to a conveyor.

14. The adjustable rotational discharge assembly of claim 13, wherein the conveyor is connected to a combine harvester.

15. The adjustable rotational discharge assembly of claim 11, wherein the pulley system includes a plurality of pulleys.

16. The adjustable rotational discharge assembly of claim 15, wherein at least one pulley is carried by the trolley assembly.

17. The adjustable rotational discharge assembly of claim 16, wherein the trolley assembly receives motion from the actuator and moves in a first direction within the opening while moving at least one cable in a first direction, resulting in rotation of the discharge chute in a first direction.

18. The adjustable rotational discharge assembly of claim 11, wherein the discharge chute is connected to a drive ring assembly, the drive ring assembly is connected to at least one cable.

19. The adjustable rotational discharge assembly of claim 11, wherein the actuator is connected to a means for operating the actuator.

20. The adjustable rotational discharge assembly of claim 19, wherein the means for operating the actuator is a foot switch.

21. The adjustable rotational discharge assembly of claim 11, wherein the actuator is an electric actuator.

22. The adjustable rotational discharge assembly of claim 11, wherein the actuator is a hydraulic actuator.

23. A combine harvester discharge conveyor including an adjustable rotational discharge assembly comprising:
a linear drive assembly having a cylinder barrel in communication with a rod, the linear motor having a first end and a second end;
a cover assembly connected to the first end of the linear motor, the cover assembly including a first section, a second section connected to the first section at a first angle, and a third section connected to the first section at a second angle;
an oblong aperture positioned through the first section of the cover assembly;
a first cable member positioned on the first section of the cover assembly;
a second cable member positioned on the first section of the cover assembly;
a pulley system carried by the cover assembly, the pulley system including a trolley assembly received within the oblong aperture and connected to the second end of the linear motor, a first pulley and fifth pulley connected to the trolley assembly, a second pulley connected to the first section of the cover assembly, a third pulley connected to the second section of the cover assembly, a fourth pulley connected to the third section of the cover assembly;
a drive ring assembly in rotational communication with the pulley system through a long cable and a short cable, the cables having a first end and a second end, the first end of the long cable connected to the first cable member, the long cable connecting the first cable member to a portion of the first pulley, the long cable connecting the first pulley to a portion of the second pulley, the long cable connecting the second pulley to a portion of the third pulley, the second end of the long cable connecting the third pulley to a portion of the drive ring assembly, another portion of the drive ring assembly connecting to the second end of the short cable, the short cable connecting the portion of the drive ring assembly to a portion of the fourth pulley, the short cable connecting the fourth pulley to a portion of the fifth pulley, the short cable connecting the fifth pulley with the second cable member, the first end of the short cable connected to the second cable member;
a discharge chute connected to the drive ring assembly, the discharge chute is adapted to rotate between a grain savings position and a grain discharge position; and
a means for operating the linear motor.

24. The adjustable rotational discharge assembly of claim 23, wherein the drive ring assembly includes a chute drive ring having at least one drive bushing, the at least one drive bushing receiving the cables between the third and fourth pulleys.

25. The adjustable rotational discharge assembly of claim 23, wherein the chute drive ring includes a chute retention element for engaging the discharge chute.

26. The adjustable rotational discharge assembly of claim 25, wherein the discharge chute includes a conveyor attachment end adapted to receive the chute retention element of the chute drive ring.

27. The adjustable rotational discharge assembly of claim 23, wherein the means for operating the linear motor includes a foot switch.
